(19) United States
(12) Patent Application Publication
(10) Pub. No.: US 2013/0339798 A1
(43) Pub. Date: Dec. 19, 2013

(54) METHODS FOR AUTOMATED SOFTWARE TESTING AND DEVICES THEREOF

(71) Applicant: Infosys Limited, Bangalore (IN)

(72) Inventors: Naresh Balaram Choudhary, Dombivili (IN); Amit Gulati, Agra (IN); Mallika Singh, Rohtak (IN); Anitha Raman, Bangalore (IN); Vinay More, Bangalore (IN)

(21) Appl. No.: 13/917,840

(22) Filed: Jun. 14, 2013

(30) Foreign Application Priority Data
Jun. 15, 2012 (IN) 2388/CHE/2012

(51) Int. Cl. G06F 11/36

(52) U.S. Cl. CPC G06F 11/3684
USPC 714/38.1

(57) ABSTRACT

Methods and devices for automated software testing. This includes identifying objects present in an application under test and identifying actions supported the objects present in application under test. Based on objects selected for testing, actions are also selected and some actions require input data to be received. Verification points, which are conditions for testing objects, are set. A test script is generated based on selected objects, actions and verification points.

This application claims the benefit of Indian Patent Application Filing No. 2388/CHE/2012, filed Jun. 15, 2012, which is hereby incorporated by reference in its entirety.

### BACKGROUND

The invention relates generally to quality assurance testing of software systems. In particular, the invention relates to a method and system to perform automated software testing.

There are two primary approaches to software quality assurance testing performed as part of software quality assurance. They are manual testing and automated testing. Manual testing is performed by a test engineer by using a set of pre-determined test cases that were formulated during software design and development. Automated testing is performed using software to control the execution of test cases. Although manual testing can identify defects present in an application under test, it is time consuming and executing tests after fixing a bug or a problem is equally laborious. Automated testing, on the other hand, may use software to execute test case, record results and identify problems.

Software used for automation testing, in particular, for testing graphical user interfaces provides an interactive record and playback mechanism for recording a series of actions performed by user on the graphical user interface. This record and playback mechanism allows repeated testing of same series of user actions for varied input parameters and expected results. Such automation testing also requires test scripts being written to perform validation of system functions. Subsequently, the test scripts also need to be modified to address changes made to the application under test. A test engineer is required to learn the software tool for automation testing and to write test scripts, instructions that are used for testing the application under test.

In order to eliminate the dependency on the test engineer's ability to write test scripts, it is possible to ease the process of automation by deskilling automated testing and the subsequent modification to the test scripts after a change is made to the application under test.

### SUMMARY

To address the above, in accordance with the present invention a system and a method for automated testing of software systems allows testing objects of application under test for at least one input value at a verification point and generates a test script for verification using a user interface.

In a preferred embodiment, the method involves identifying at least one object for verification from an application under test (AUT) and determining at least one action supported by the at least one object. Subsequently, a value is received for the selected object and a point at which the verification is performed is also selected. A test script is generated for the verification of at least one object for at least one action, at least one input value and at least one verification point.

In another aspect, a user interface of the system is used for receiving a location of the application under test. This location on a file directory is read for identifying the objects of the application under test and for the identified objects, the actions supported by the object may be identified. The user interface is used to receive the point of verification and at least one value for the objects. After this, a test script is generated which when executed may test the application under test for the identified object at the point of verification.

In yet another aspect, the user interface allows selection of a type of object present in an application under test. The types of objects may be listed in a drop down box for selection. This allows selection of objects of one type and testing the objects of one type with multiple values.

The present invention relates to a system for automated testing of software systems. The system includes an identifier module configured to perform identification of objects present in an application under test and the identifier module also identifies actions supported by the objects present in the application under test. Using an input module configured to receive values for the object and a verification point. Test script generator module is used to generate a test script which may be executed to perform verification of the object using the input values and actions at the verification point.

### BRIEF DESCRIPTION OF DRAWINGS

These and other features, aspects, and advantages of the present invention will be better understood when the following detailed description is read with reference to the accompanying drawings in which like characters represent like parts throughout the drawings, wherein:

FIG. 1 illustrates a user interface of the system used for automated testing of software systems.

FIG. 2 is a block diagram of system in accordance with an embodiment of the invention.

FIG. 3 represents a flowchart describing the process involved in an embodiment.

FIG. 4 represents a flowchart describing the process involved in an embodiment.

FIG. 5 illustrates a generalized example of a computing environment 500.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The present invention relates to a method and system to perform automated software testing. Software testing is conducted to identify the quality of a software system based on verifying whether software system meets the requirements stated the software requirements and design specifications. Regression testing is a type of software testing that is performed to discover new defects in the functional and non-functional areas after a system is modified for addition of a new feature, enhancement or application of a patch. An application under test (AUT) is a software system that may be subject to regression testing or any other type of software testing for identification of defects. Examples of applications include but are not limited to web applications and desktop applications.

An object of the application under test refers to an entity under the object oriented paradigm which can be manipulated by using programming languages. Objects of graphical user interface in an application under test may contain parameters which represent the state and appearance of the object and have functions that are pre-determined for particular actions that can be invoked using the object.

Automated testing tools in general use a record and playback mechanism wherein a series of interactions with the user interface of the application under test is recorded at first and the same sequence of user interactions with the user interface of the application under test is played back during the time of testing.

In software testing, a test script contains a series of instructions that may be performed on an application under test. Test scripts are used in automated testing and contain parameters that may be supplied to the objects in an application under test. Test scripts also contain verification points, which are inserted while recording user interactions with the system and during the execution of test scripts the verification points capture and store object information. A verification point for an object is used for confirming the state of an object. A list of properties of an object may be set to an expected value and these values can be compared by invoking a verification point.

A data pool is a collection of data values that serves as a repository to supply data to a test script during the playback of interactions with the graphical user interface of the application under test. Examples of data pool include but are not limited data values stored in columns of comma-separated values (CSV) files and tab-separated values (TSV) files.

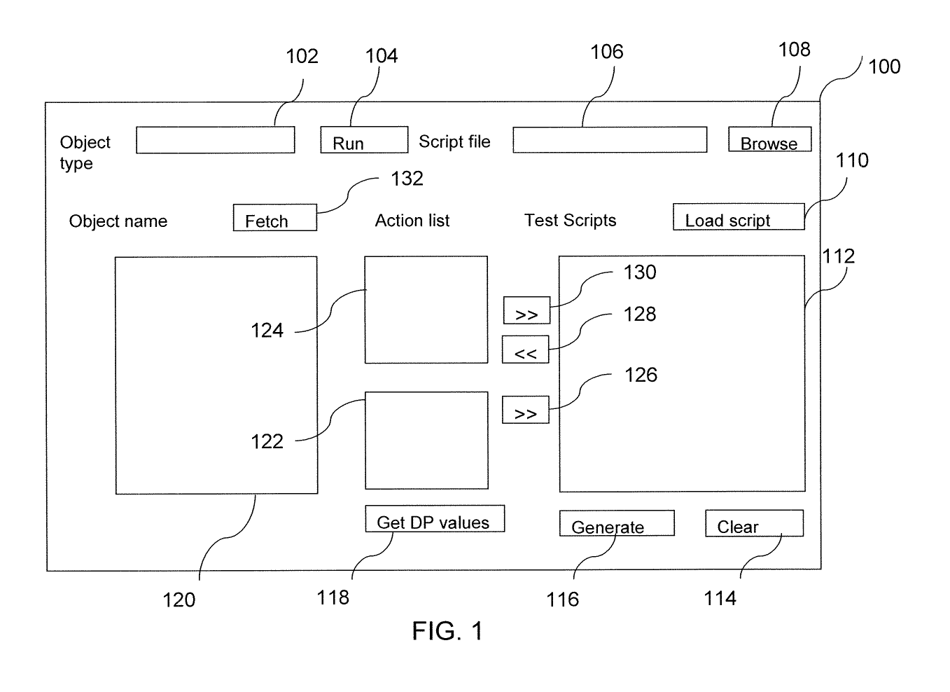

FIG. 1 illustrates a user interface of the system used for automated testing of software systems.

In a preferred embodiment, the user interface 100 of the automated testing tool includes an object type drop down box 102 which will list all different types of objects present in the application under test (AUT). Examples of types of object include but are not limited to text box, radio button, text area and drop down box. On selection of the particular object type and press of the button fetch 132 the names of different objects of the type of object selected from dropdown box 102 are listed in the text area 120. On selection of an object name in text area 120, the list of actions supported by the object is displayed in text area 124. The verification points are displayed in the text area 122. The button 118 is used to fetch data pool values corresponding to verification points listed in text area 122. A button 130 is used for selecting at least one action item from list of actions 124 to the test script. Using this button 124, it is possible to select a series of actions for multiple objects to be tested using a test script. It may be possible to add verification points from text area 122 to be added to the test script by using button 126. Button 128 is used to remove the actions from text area 112. Finally, the button 116 is used to generate the test script for the actions and the objects selected using text areas 120 and 124 respectively. A button 114 is used to clear the text area 112, which contains the test script generated.

In another embodiment, the user interface 100 of the automated testing tool includes a file select button named “Browse” 108 which allows selection of an existing test script and once selected a file path of the test script is displayed in text box 106. On press of the Load script button 110, the test script is displayed in text area 112. Subsequently, objects from application under test (AUT) and actions supported by the objects can be added for testing to an existing test script using buttons 130 and 126 as explained earlier. The button 128 is used to remove actions present in the test script. Thus, the automated testing tool allows modification of test scripts and subsequent generation of modified test scripts.

In another embodiment, the verification is performed by comparing a property of the object after performing the selected action with an input value received using the user interface.

In another embodiment, the test script is executed for verification and failure in verification by comparing a property of the object after performing the selected action with an input value received using the user interface indicates a problem with technical implementation.

In another embodiment, after generation of test scripts, the test scripts are executed to identify problems with technical implementation, a test report is generated. The test report may contain properties of the object before and after execution of the test script.

In another embodiment, the execution of test script is independent of the change in hierarchy of objects present in the application under test.

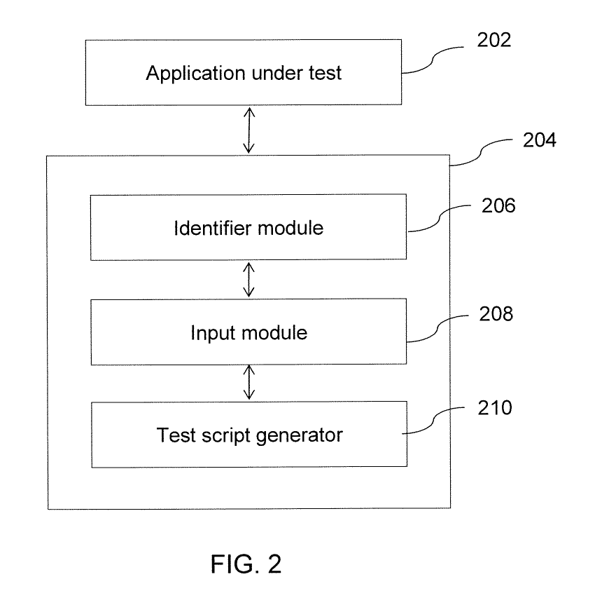

FIG. 2 is a block diagram of system in accordance with an embodiment of the invention.

The system includes an identifier module 206, an input module 208 and a test script generator 210. The input module 208 interacts with the application under test 202 in order to identify objects for verification from the application under test and identify actions supported by the identified objects. For example, an application under test may be a web page of a web application which contains a form that includes fields for data input. The input module parses the HTML (Hyper-Text Markup Language) to identify the objects present in a web page. The actions and properties supported by objects on a web page may be pre-defined and be stored in a comma separated value file (CSV). The objects and their supported actions are now displayed on the user interface on text areas 120 and 124 of the user interface shown in FIG. 1 respectively. Subsequently, the input module 208 receives user input for actions that require input from user, for example, SetText operation requires the user to assign a text to a text box in HTML. The input module 208 also receives a selection of verification points displayed on the user interface as described above. By using the objects and actions identified by the identifier module 206 along with user input received by the input module 206, the test script generator 210 generates a test script which is displayed on the text box 112.

In another embodiment, the web application can have multiple web pages and objects present in the web application may be present in different web pages which are linked to each other in a certain workflow. Testing such a web application is made possible using this system.

In another embodiment, the system allows the generation of a test report. After generation of a test script using the steps described earlier. The system may also have a button on the user interface which can be used to initiate execution of the test scripts. The results of the test script execution may be presented in the form of a test report. A test report can be of a HTML, text or a comma separated value file.

In another embodiment, after the execution of a test script, a change in value of a property of an object in the application under test can be identified by using the input received using the input module 208 can be identified by comparing an expected value of the property present in the test script with the actual value of property of the object present in the application under test.

In another embodiment, the system can be adapted to include a text box on the user interface to set a time interval in which a test script is required to be executed periodically. Upon the execution of test scripts, test reports may be generated at scheduled time intervals.

In another embodiment, a hierarchy of the objects present in the application under test, when changed, does not affect execution of the test scripts.

This can be achieved by using a copy of objects present in an application under test in an individual file and allowing the input module 208 to read the property of the objects from the copy of objects present in the application under test.

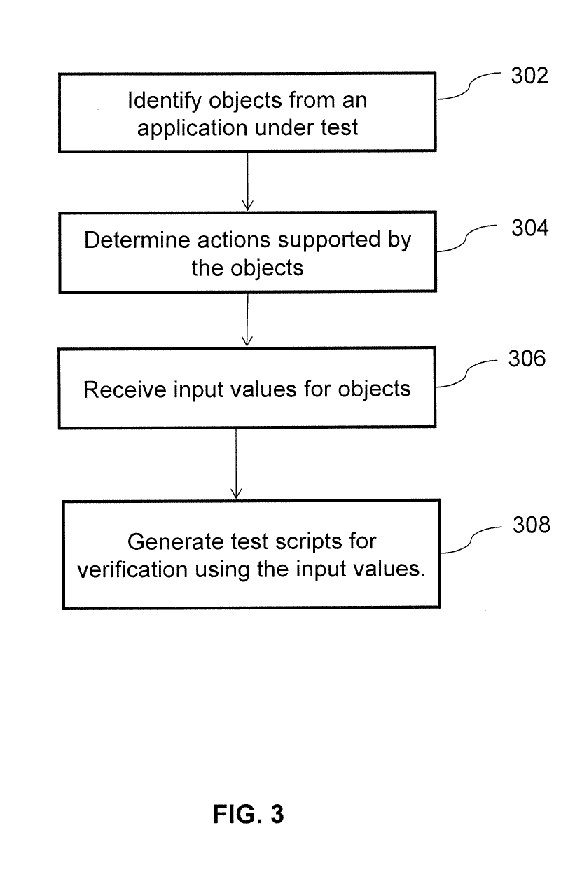

FIG. 3 represents a flowchart describing the process involved in an embodiment.

At step 302, identification of objects present in an application under test is performed. Identification of objects can be performed by using an object map that contains all objects of an application under test. The identification operation may also be performed at various instances when the application under test is executed under various conditions, parameters and test environments. After the identification of the objects, at step 304, the actions supported by the objects are found, the actions may be found by using a repository or a database where different types of objects are mapped to actions that are supported by the objects. The actions supported by the objects are commonly standardized for graphical user interfaces. Objects may need to be initialized in some cases. The actions supported by the objects may be invoked using a function that is defined for a particular type of the object. The actions supported by a selected object may require input value, which initializes the object, and an input value is received at 306. At step 308, a test script is generated for verification using the input value for the selected object and the actions.

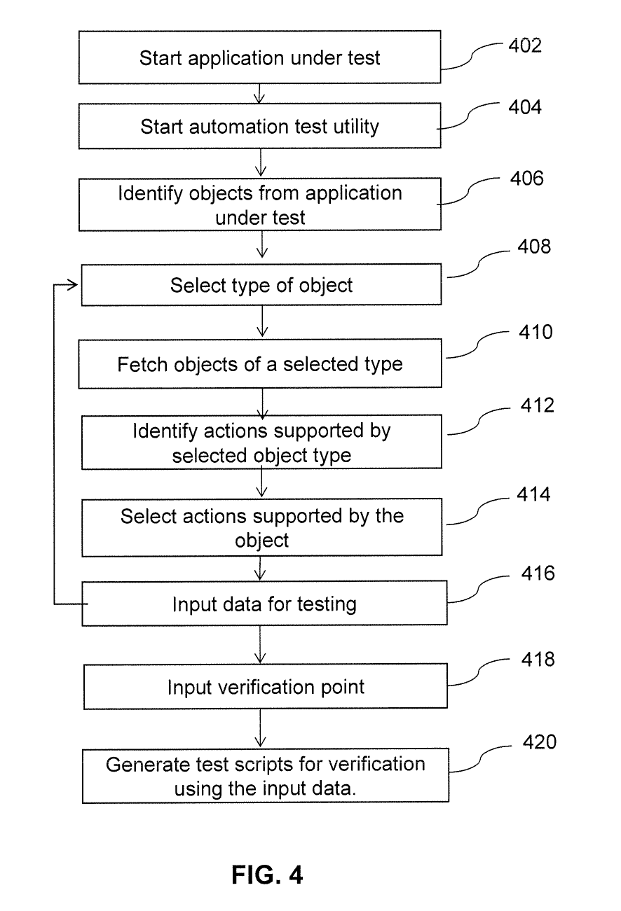

FIG. 4 represents a flowchart describing the process involved in an embodiment.

With reference to FIG. 4, at step 402, the execution of an application under test is started and at step 404 the automated testing tool is run after this. The automated testing tool, at step 406, identifies various objects present in the application under test. Identification of objects and the initialization is described earlier in conjunction with FIG. 3. The types of objects present in the application under test are listed and a type of object is selected at step 408. Objects of the selected type are fetched at step 410. On selection of a type of object, actions supported by the selected object type are identified at step 412. From the list of actions supported by a type of object, one action is selected at step 414. If the action requires input data the input data is received at step 416. Multiple objects and actions can be selected by repeating steps 408 to step 416. This allows a sequence of user interactions with the application under test to be recorded and may be used for playback. Upon selecting an action, verification points are received at step 418. A verification point is used for confirming the state of an object. The verification point shown on the user interface may contain a reference to data pool. A test script is generated for verification using the input value for the selected object and the actions at step 420.

Upon the generation of the test script, it may be used for execution that simulates playback of the recorded sequence of user interactions with an application under test. The results of the execution may be presented to as a test report. The test report would contain initial state of objects and the current state of objects, after the execution of test script.

In the above embodiments, there is no user supplied test script code. The test script is generated in an automated manner by allowing the user to record user interface actions performed using options on the graphical user interface as described in FIG. 1. Hence, by using the system, a novice user who is not familiar with writing test scripts can generate test scripts for a series of actions that are to be recorded and played back for testing.

### Exemplary Computing Environment

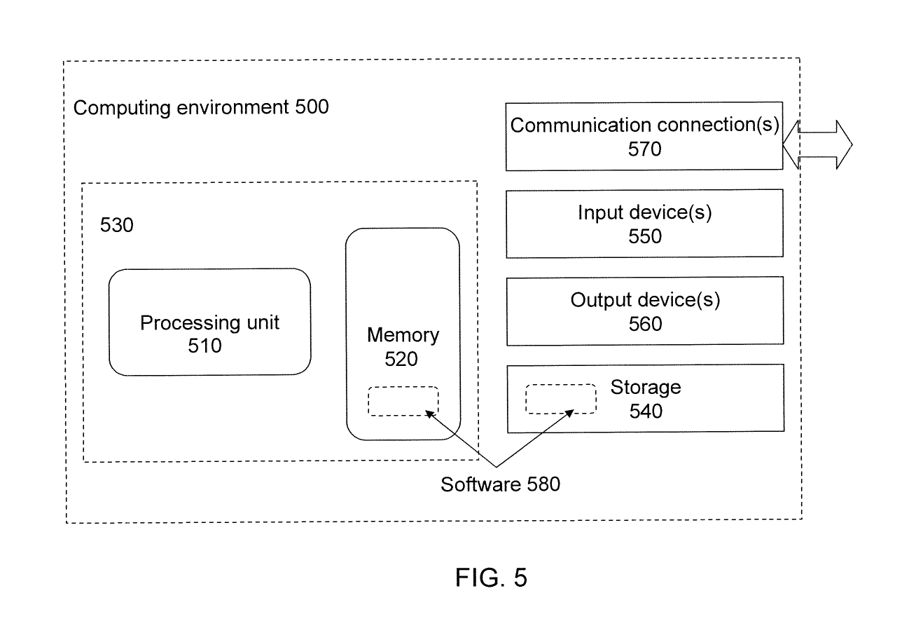

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method for automated software testing, the method comprising:
identifying, by a software testing processing apparatus, at least one object from an application under test(AUT);
determining, by the software testing processing apparatus, at least one action supported by the identified object;
receiving, by the software testing processing apparatus, at least one input value for property of the at least one object;
receiving, by the software testing processing apparatus, at least one verification point for the at least one object; and
generating, by the software testing processing apparatus, a test script executable to perform verification of the at least one object and the at least one action using the at least one input value at the at least one verification point.

2. The method of claim 1 wherein the verification of the at least one identified object is performed by comparing the at least one object with the at least one input value.

3. The method of claim 1 further comprises comparing, by the software testing processing apparatus, at least one property of at least one object selected from an application under test and the at least one input value.

4. The method of claim 1 wherein failure of verification indicates a problem.

5. The method of claim 1 wherein execution of the test script identifies a change in a value of a property in at least one object of the application under test.

6. The method of claim 1 wherein a graphical user interface of the application under test comprises at least one of text box, radio button, text area or drop down box.

7. A software testing processing device comprising:
a processor coupled to a memory and configured to execute programmed instructions stored in the memory comprising:
identifying at least one object from an application under test (AUT);
identifying at least one action supported by the identified object;
receiving at least one input for the at least one property of at least one object and at least one verification point for the at least one object; and
generating a test script executable to perform verification of the at least one object and the at least one action using the at least one input value at the at least one verification point.

8. The device of claim 7 wherein a graphical user interface of the application under test comprises at least one of text box, radio button, text area or drop down box.

9. The device of claim 7 wherein the verification of the at least one identified object is performed by comparing the at least one object with the at least one input value.

10. The device of claim 7 further comprising comparing the at least one property of at least one object and at least one input value.

11. The device of claim 7 further comprises automatically generating a test report.

12. The device of claim 11 wherein a test report is at least one of a text file or a comma-separated value file.

13. The device of claim 7 wherein failure of verification indicates a problem.

14. The device of claim 7 wherein execution of the test script identifies a change in a value of a property in at least one object of the application under test.

15. The device of claim 7 wherein execution of the test script is allowed to repeat at a scheduled time interval.

16. The device of claim 7 wherein the execution of the test script is independent of the hierarchy of the objects in the application under test.

17. The device of claim 7 wherein the input module receives a text input.

18. The device of claim 7 wherein the identifier module is further configured to read configuration files of the application under test.

19. A non-transitory computer readable medium having stored thereon instructions for automated software testing comprising machine executable code which when executed by a processor, causes the processor to perform steps comprising:
identifying at least one object from an application under test(AUT);
determining at least one action supported by the identified object;
receiving at least one input value for at least one property of the at least one object;
receiving at least one verification point for the at least one object; and
generating a test script executable to perform validation of the at least one object and the at least one action using the at least one input value at the at least one verification point.
